(19) United States
(12) Patent Application Publication
(10) Pub. No.: US 2009/0015609 A1
(43) Pub. Date: Jan. 15, 2009

(54) INKJET IMAGE FORMING APPARATUS

(75) Inventor: Hyun Jin CHOO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/115,728

(22) Filed: May 6, 2008

(30) Foreign Application Priority Data
Jul. 13, 2007 (KR) 2007-70521

(51) Int. Cl. B41J 29/38

(52) U.S. Cl. 347/9

(57) ABSTRACT

An inkjet image forming apparatus includes an ink detection unit including a light-receiving unit and a light-emitting unit facing each other. The ink detection unit is located under a printer head including several nozzles discharging the ink. The controller transmits an enable signal to the ink detection unit, so that the ink is detected by the enable signal while ink droplets enter and pass the optical signal. The ink detection unit alternately performs a first operation to detect the ink by the enable signal and a second operation to non-detect the ink.

### CROSS-REFERENCE TO RELATED APPLICATIONS

This application claims priority under 35 U.S.C. §119(a) from Korean Patent Application No. 2007-0070521, filed on Jul. 13, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus to check a nozzle status of a printer head.

2. Description of the Related Art

Generally, the inkjet image forming apparatus discharges ink to a recording medium via a nozzle of a printer head, so that the ink forms the image. The images of the inkjet image forming apparatus are affected by a status of individual nozzles. For example, if the printer head does not discharge the ink due to foreign materials inserted into the nozzle holes or the heating resistance material, or if the printer head improperly discharges the ink although the ink has been discharged from the printer head, the image formed on the recording medium may unexpectedly include a white line, so that image quality is deteriorated.

The inkjet image forming apparatus can recognize the nozzle status according to an amount of ink discharged from the printer head, so that a method to use an ink detection unit to detect the amount of discharged ink has been well known in the art.

Conventionally, the inkjet image forming apparatus detects the amount of ink discharged from the printer head using a pair of photo-detectors composed of light-emitting and light-receiving elements. The light emitted from the light-emitting element located under the printer head is applied to the light-receiving element, and is then converted into an electrical signal.

The ink discharged from the individual nozzles of the printer head equipped with several nozzles passes the light signal emitted from the light-emitting element. In this case, if ink droplets pass the light signal, the droplets block the light signal, and the electrical signal generated from the light-receiving element is changed according to the light-blocked degree caused by the ink droplets. Therefore, the nozzle status of the printer head can be recognized on a basis of the output signal of the light-receiving element. Also, there is no change in the electrical signal generated from the light-receiving element before and after a controller applies the ink discharging command to the printer head, and the ink droplets not being discharged from the printer head due to the clogged ink nozzle can be recognized.

In order to recognize the nozzle status of the printer head using the photo-detector composed of the light-emitting and light-receiving elements, a size of each ink droplet discharged from the nozzle of the printer head should be sufficiently large, or a sufficient number of discharged ink droplets is required. If several nozzles are arranged in a single head chip, or several unit-head chips are arranged in a paper-width direction, a large amount of ink discharged from each nozzle unavoidably increases and a long period of time is required to apply the above-mentioned detection method to all the nozzles.

In order to recognize the nozzle status of the above-mentioned printer head, there is needed a new method to effectively recognize the nozzle status of the printer head, so that the method can reduce not only an amount of consumed ink but also the time consumed for the detection operation when the ink-discharging amount of the printer head is detected by the photo-detector composed of the light-emitting and light-receiving elements.

### SUMMARY OF THE INVENTION

The general inventive concept provides an inkjet image forming apparatus to restrict a detection time of ink droplets discharged from a printer head, reducing an amount of ink consumption, and reducing a detection time.

The general inventive concept also provides an inkjet image forming apparatus to recognize a nozzle status of the printer head on a basis of detection time of ink droplets deflection-discharged from the printer head.

Additional aspects and utilities of the general inventive concept will be set forth in part in the description which follows and, in part, will be obvious from the description, or may be learned by practice of the general inventive concept.

The foregoing and/or other aspects and utilities of the general inventive concept may be achieved by providing an inkjet image forming apparatus including a printer head equipped with a nozzle to discharge ink, an ink detection unit to detect the ink discharged from the printer head, and to output the detected ink in a form of an electric signal, and a controller to limit an ink detection time of the ink detection unit.

The ink detection unit may include a photo-detector equipped with a light-receiving element and a light-emitting element, wherein the light-receiving element restricts an ink detection operation thereof by the controller.

The light-emitting element and the light-receiving element may go across a flying path of ink droplets discharged from the printer head, and are mounted to both sides of the ink detection unit.

The controller may restrict an ink detection operation of the light-receiving element during other periods except during a specific time in which ink droplets discharged from the printer head pass through an optical signal ranging from the light-emitting element to the light-receiving element.

The controller may begin to detect the ink from a specific time at which ink droplets discharged from the printer head enter an optical signal ranging from the light-emitting element to the light-receiving element, continuously performs the ink detection during a specific time corresponding to a width of the optical signal, and transmits an enable signal preventing the ink detection to the light-receiving element when the ink droplets escape from the optical signal.

The enable signal may include a first period and a second period, wherein the first period substantially detects the ink, and the second period does not substantially detect the ink.

The controller may adjust a location of the first period of the enable signal according to a variation of an interval between the printer head and the ink detection unit.

The foregoing and/or other aspects and utilities of the general inventive concept may also be achieved by providing an inkjet image forming apparatus including a printer head equipped with a plurality of nozzles, an ink detection unit which includes a light-emitting element and a light-receiving element spaced apart from the printer head by a predetermined distance to transmit or receive an optical signal, and to alternately perform a first operation to detect ink or a second operation to non-detect the ink, a comparator to compare an output-signal level of the light-receiving element with a reference value, a memory to store specific information to calculate a specific time at which ink droplets discharged from the printer head enter the optical signal, and a controller to recognize an ink-discharging amount upon receiving the comparison result from the comparator, and to restrict an ink-discharging operation of the light-receiving element using an enable signal, so that the first operation is conducted in a range from a start time at which the ink droplets enter the optical signal using the information stored in the memory to an end time at which the ink droplets escape from the optical signal, and to perform the second operation after the ink droplets escape from the optical signal.

The foregoing and/or other aspects and utilities of the general inventive concept may also be achieved by providing an inkjet image forming apparatus including a printer head equipped with a nozzle used for a deflected-discharging operation, an ink-detection unit to detect ink droplets deflection-discharged from the printer head, and a controller to recognize a nozzle state of the printer head to discharge the deflection-discharging operation.

If the detection time of the ink droplets deflection-discharged from the printer head leads a reference time or lags behind the reference time, the controller may determine that the nozzle is in a poor status.

The apparatus further includes a memory to store information calculating the detection time of the ink droplets deflection-discharged.

The information stored in the memory may include an ink-discharging speed, a moving distance between recording-medium locations which are different according to a vertical discharging action and a deflection-discharging action, a deflection angle, and a flying distance provided when the ink droplets discharged from the printer head performing the deflection-discharging operation reach an optical signal.

The controller can determine the ink-droplet recognition time while the respective ink droplets are flying in correspondence with a width of the light.

The controller may further determine ink-droplet recognition time by recognizing a speed of the respective ink droplets ejected from the printer head and a distance between the ink detection unit and the printer head.

The ink detection unit may block a light signal after the respective ink droplets have reached the light.

The foregoing and/or other aspects and utilities of the general inventive concept may also be achieved by providing a method of operating an inkjet image forming apparatus, the method including ejecting ink droplets, transmitting a light to detect a presence of the ink droplets and determining an ink-droplet recognition time while the respective ink droplets are flying in correspondence with a width of the light.

The foregoing and/or other aspects and utilities of the general inventive concept may also be achieved by providing a computer-readable recording medium having embodied thereon a computer program to execute a method, wherein the method including ejecting ink droplets, transmitting a light to detect a presence of the ink droplets and determining an ink-droplet recognition time while the respective ink droplets are flying in correspondence with a width of the light.

### BRIEF DESCRIPTION OF THE DRAWINGS

These and/or other aspects and utilities of the general inventive concept will become apparent and more readily appreciated from the following description of the embodiments, taken in conjunction with the accompanying drawings of which:

FIG. 1 is a block diagram illustrating an inkjet image forming apparatus according to an embodiment of the present general inventive concept;

FIG. 2 is a conceptual diagram illustrating an operation to detect ink droplets using an ink detection unit applied to an inkjet image forming apparatus according to an embodiment of the present general inventive concept;

FIG. 3 is a conceptual diagram illustrating an ink detection unit applied to an inkjet image forming apparatus located between a printer head and a recording medium according to an embodiment of the present general inventive concept;

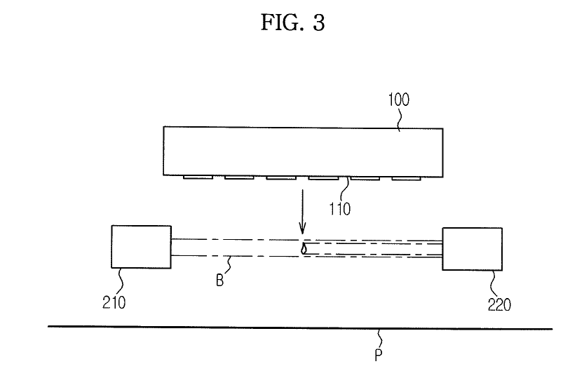

FIG. 4 is an embodiment of a timing diagram illustrating a specific case in which the inkjet image forming apparatus restricts an ink detection operation according to an embodiment of the present general inventive concept;

FIG. 5 is a conceptual diagram illustrating a specific case in which a printer head performs a deflection-discharging operation according to another embodiment of the present general inventive concept;

FIG. 6 is a conceptual diagram illustrating an operation to detect ink deflection-discharged by an ink detection unit according to another embodiment of the present general inventive concept;

FIG. 7 is a timing diagram illustrating an operation to determine a nozzle state according to a detection time of the ink deflection-discharged from a printer head according to another embodiment of the present general inventive concept; and

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below to explain the present general inventive concept by referring to the figures.

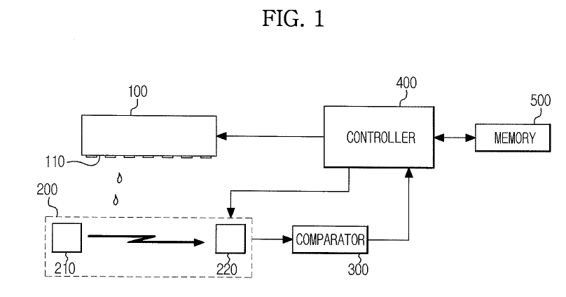

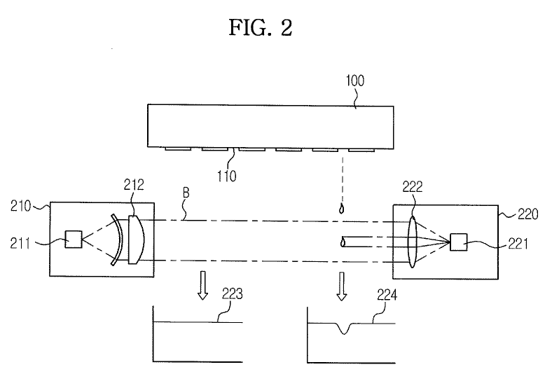

FIG. 1 is a block diagram illustrating an inkjet image forming apparatus according to an embodiment of the present general inventive concept; FIG. 2 is a conceptual diagram illustrating an operation to detect ink droplets using an ink detection unit applied to the inkjet image forming apparatus according to an embodiment of the present general inventive concept.

Referring to FIGS. 1 and 2, the inkjet image forming apparatus according to the present general inventive concept includes a printer head 100 equipped with one or more nozzles (nozzle) 110, and an ink detection unit 200 located under the printer head 100 to detect ink droplets discharged from the nozzle 110.

The ink detection unit 200 may be a photo-detector composed of a light-emitting element 210 and a light-receiving element 220, to transmit or receive a parallel light (B) according to the detection or non-detection of ink droplets.

In this case, the light-emitting element 210 includes the light source 211, and may further include a light-directing member 221 to direct the light signal generated from the light source 211 so that the light signal proceeds in parallel without occurring any light-scattering. The light-receiving element 220 includes the photo-detector 221 to convert the received light signal into an electrical signal, and may further include a light-directing member 222 to collect the light signal and directing the collected light signal to the photo-detector 221.

If the nozzle 110 of the printer head 100 does not discharge ink droplets or the discharged ink droplets do not pass the parallel light (B) ranging from the light-emitting element 210 to the light-receiving element 220, the light-receiving element 220 outputs the signal 223 of a predetermined level. In the meantime, if the ink droplets discharged from the nozzle 110 of the printer head 100 blocks some portion of the parallel light (B) from the light-emitting element 210 to the light-receiving element 220, the level of the output signal 224 generated from the light-receiving element 220 is changed.

In order to recognize whether the nozzle 110 discharges the ink and also recognize the nozzle status upon receiving the output signals 223 and 224 from the light-receiving element 220, the comparator 300 is connected to an output terminal of the ink detection unit 200. The comparator 300 compares the output-signal level of the light-receiving element 220 with a reference value, and transmits the comparison result to the controller 400.

The controller 400 recognizes an amount of discharged ink upon receiving the comparison result from the comparator 300, and stores information indicating a nozzle status associated with the ink-discharging amount in the memory 500. By an operation panel (not illustrated) contained in a user interface or another operation panel (not illustrated) contained in an external device connected to a network communication unit, information associated with the nozzle status is displayed, so that this information may also be provided to a user or a repairman.

A width of the parallel light (B) proceeding from the light-emitting element 210 to the light-receiving element 220 is extended, many ink droplets pass through an extended width of the parallel light (B), and the output signal of the light-receiving element 220 is changed by the light-blocked degree caused by the discharged ink droplets. However, there is needed a photo-detector to generate the parallel light having the wide width and receiving the parallel light, resulting in an occurrence of inefficient production costs.

The present embodiment illustrates that the inkjet image forming apparatus restricts the ink detection time, so that the image forming apparatus substantially performs the ink detection operation while the ink droplets pass through the parallel light, without extending the width of the parallel light. Indeed, although the width of the parallel light needs to be extended, the extended range is restricted within a relatively narrow range.

The ink detection unit 200 is spaced apart from the printer head 100 by a predetermined distance, and is located between the printer head 100 and the recording medium (P), so that the ink detection unit 200 detects the ink discharged from the nozzle 110.

The ink detection unit 200 pre-recognizes an ink discharging speed due to a necessity of a manufacturing/testing process of the printer head 100, and pre-recognizes the distance between the printer head 100 and the recording medium P and the distance between the printer head 100 and the ink detection unit 200. The above-mentioned recognition information is pre-stored in the memory 500.

The ink detection unit 200 has recognized the speed of ink droplets discharged from the printer head 100 and the distance between the printer head 100 and the ink detection unit 200, so that the ink detection unit 200 can recognize the flying time of the discharged ink droplets reaching the parallel light (B).

The ink detection unit 200 can block the light signal after the ink droplets have reached the parallel light B, so that the substantial ink-droplet recognition time is decided while the ink droplets are flying in correspondence with the width of the parallel light.

The controller 400 controls the printer head 100 to discharge the ink at a predetermined discharging frequency. Therefore, the ink discharging operation of the individual nozzles contained in the printer head 100 is periodically conducted.

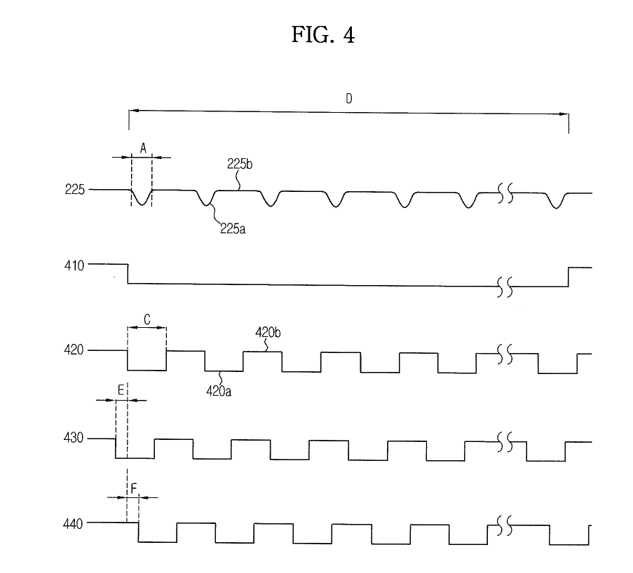

As illustrated in the timing diagram of FIG. 4, if the printer head 100 discharges the ink at the predetermined discharging frequency upon receiving a control signal from the controller 400, the output signal of the light-receiving element 225 periodically generates the period A in which the signal level of a predetermine period D is changed, so that a variable signal level 225a and a predetermined-signal level 225b are alternately output.

In order to continuously perform the ink detection operation during the total period D, the controller 400 transmits a first enable signal 410 to the ink detection unit 200 during the period D, so that the ink detection unit 200 is enabled during the period D.

The present embodiment applies a second enable signal 420 to the ink detection unit 200, so that the second enable signal 420 is used as a restriction signal to restrict the detection time of the ink droplets.

The second enable signal 420 includes a first period 420a and a second period 420b. The first period 420a may be equal to the period A in which the signal level is changed, or may be longer than the period A. The narrower the interval of the first period 420a, the shorter the detection time. The wider the interval of the first period 420a, the longer the detection time. So, the first interval 420a may be properly decided in consideration of the above-mentioned characteristics.

If the ink detection unit 200 receives the second enable signal 420, the ink detection unit 200 performs the detection operation during the first interval 420a, and outputs a resultant signal. However, the ink detection unit 200 does not perform the detection operation. Although the ink detection unit 200 outputs the resultant signal caused by the detection, this resultant signal is not handled by the comparator 300.

By the second enable signal 420 applied from the controller 400 to the ink detection unit 200, the detection operation of the ink detection unit 200 can be restricted. In this case, the output signal of the light-receiving element 220 can be signal-processed within the first interval 420a including the ink-droplet detection information. So, if the discharging process of the ink droplets is shortened as compared to the conventional art, there is no problem in discriminating the nozzle status. In other words, the present embodiment selectively extracts the output signal of the light-receiving element during many first intervals 420a contained in the period D, and decides the ink discharging status on a basis of the extracted signal to discriminate the nozzle status while using the period shorter than the conventional period (D). The shortened period may be set to at least one interval 420a of the period D.

The controller 400 synchronizes the first interval 420a of the second enable signal 420 with the period A in which the signal level is changed, and generates the synchronized result. In this case, the controller 400 recognizes a speed of ink droplets discharged from the printer head 100 and a distance between the printer head 100 and the ink detection unit 200, calculates the flying time from the above distance to the parallel light B, and forms a second enable signal 420 on a basis of the flying time and the discharging frequency of the ink droplets.

When the printer head 100 or the ink cartridge including the printer head 100 is installed in the inkjet image forming apparatus, the predetermined distance between the recording medium P and the printer head 100 may be changed to another.

In this case, a location of the first interval may be changed to another, so that a phase of the second enable signal needs to be adjusted. In more detail, the controller 400 transmits a third enable signal 430 to generate the first interval ahead of a predetermined time E to the ink detection unit 200, or transmits a fourth enable signal to generate the first interval behind a predetermined time F to the ink detection unit 200. In this case, the ink detection unit 200 receives the third and fourth enable signals 430 and 440, and restricts the ink detection operation according to the adjusted time.

In the meantime, the inkjet image forming apparatus according to another embodiment of the present general inventive concept includes a printer head to deflect-discharge the ink in various ways. Other constituent components other than the printer head are substantially equal to the above-mentioned constituent components of the above-mentioned first embodiment, so the components are denoted by the same numerals as the previous embodiment.

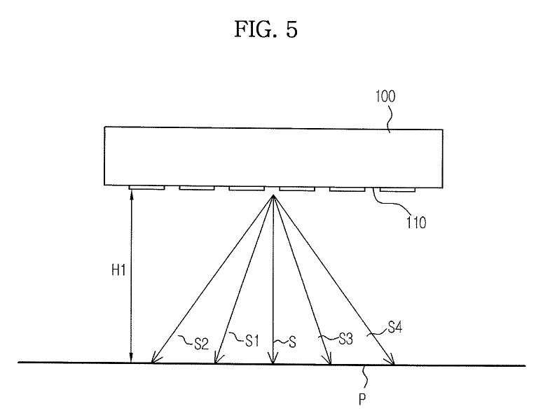

Referring to FIG. 5, the printer head 100 for deflection-discharging the ink is spaced apart from the recording medium P by a first distance (H1), so that the printer head 100 discharges the ink in a vertical direction via the nozzle 110, and discharges the ink in the directions S1, S2, S3, and S2 deflected at a predetermined angle on a basis of the vertical direction.

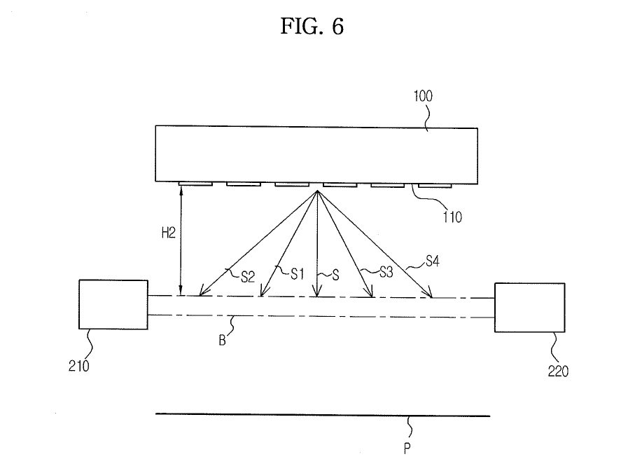

Referring to FIG. 6, the ink detection unit 200 may be located between the printer head 100 to perform the deflection-discharging operation and the recording medium P. In this case, the ink detection unit 200 may be spaced apart from the printer head 10 by a second distance H2 shorter than the first distance H1.

As described above, in an embodiment of the present general inventive concept, the printer head 100 is manufactured for the deflection discharging, and tests the printer head 100. In this case, the present embodiment, the ink-discharging speed, the moving distance from a reference location of the recording medium during the vertical discharging action to the recording medium location during the deflection discharging action, the deflection angle, and the flying distance made when the ink droplets reach the parallel light (B) is recognized. The above-mentioned recognized information is pre-stored in the memory 500.

Therefore, during the deflection discharging action, in the present embodiment, the nozzle status on a basis of the detection time of the deflection-discharged ink can be recognized.

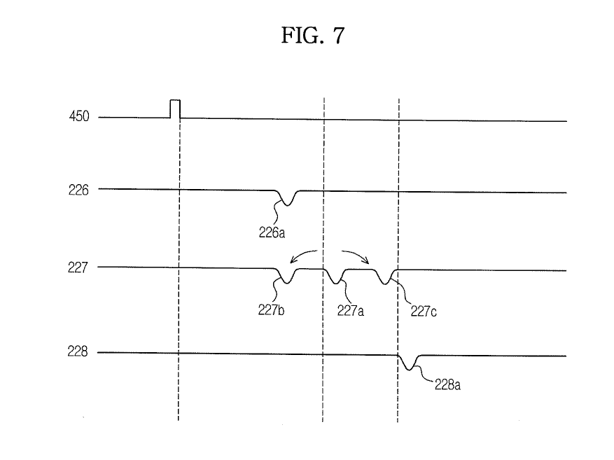

FIG. 7 illustrates an example in which a vertical discharging action is conducted once and a deflection discharging action is conducted two times.

The controller 400 transmits a start signal 450 to start the deflection discharging operation to the printer head 100 to perform the deflection discharging operation. Therefore, the printer head 100 discharges the ink once in the vertical direction, and performs the deflection discharging operation two times at intervals of a predetermined time. The ink detection unit 200 outputs a first output signal 226 including a variable-signal level 226a changed when the light signal is blocked by the once-vertically-discharged ink droplets. The light signal is blocked by the ink droplets firstly-deflection-discharged from the printer head 100 to perform the deflection discharging action, so that the ink detection unit 200 outputs a second output signal 227 including the variable signal level 227a in which the signal level is changed. Then, the light signal is blocked by the deflection-discharged ink droplets, and the ink detection unit 200 outputs a third output signal 228 including the variable signal level 228a in which the signal level is changed. The above-mentioned variable signal levels 226a, 227a, and 228a occur at intervals of a predetermined time.

However, an abnormal discharging operation may occur due to a poor nozzle status. For example, the nozzle status is very poor during the first deflection discharging action, so that the abnormal variable signal level 227b may occur ahead of the normal variable signal level 227a, or another abnormal variable signal level 227c may also occur behind the normal variable signal level 227a. As a result, the controller 400 can recognize the nozzle status of the printer head performing the deflection discharging on a basis of the recognition result of the above-mentioned variable signal levels.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, the inkjet image forming apparatus according to various embodiments of the present general inventive concept restricts a detection time of ink droplets discharged from a printer head, reduces an amount of ink consumption, and reduces a detection time. Also, the inkjet image forming apparatus easily recognizes a nozzle status of the printer head on a basis of the detection time of ink droplets deflection-discharged from the printer head.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An inkjet image forming apparatus, comprising:
a printer head equipped with a nozzle to discharge ink;
an ink detection unit to detect the ink discharged from the printer head, and to output the detected ink in a form of an electric signal; and
a controller to limit an ink detection time of the ink detection unit.

2. The apparatus according to claim 1, wherein the ink detection unit comprises:
a photo-detector equipped with a light-receiving element and a light-emitting element, wherein the light-receiving element restricts an ink detection operation thereof by the controller.

3. The apparatus according to claim 2, wherein the light-emitting element and the light-receiving element go across a flying path of ink droplets discharged from the printer head, and are mounted to both sides of the ink detection unit.

4. The apparatus according to claim 2, wherein the controller restricts an ink detection operation of the light-receiving element during other periods except during a specific time in which ink droplets discharged from the printer head pass through an optical signal ranging from the light-emitting element to the light-receiving element.

5. The apparatus according to claim 1, wherein the controller begins to detect the ink from a specific time at which ink droplets discharged from the printer head enter an optical signal ranging from the light-emitting element to the light-receiving element, continuously performs the ink detection during a specific time corresponding to a width of the optical signal, and transmits an enable signal preventing the ink detection to the light-receiving element when the ink droplets escape from the optical signal.

6. The apparatus according to claim 5, wherein the enable signal comprise:
a first period and a second period,
wherein the first period substantially detects the ink, and the second period does not substantially detect the ink.

7. The apparatus according to claim 5, wherein the controller adjusts a location of the first period of the enable signal according to a variation of an interval between the printer head and the ink detection unit.

8. An inkjet image forming apparatus, comprising:
a printer head equipped with a plurality of nozzles;
an ink detection unit which includes a light-emitting element and a light-receiving element spaced apart from the printer head by a predetermined distance to transmit or receive an optical signal, and to alternately perform a first operation to detect ink or a second operation to non-detect the ink;
a comparator to compare an output-signal level of the light-receiving element with a reference value;
a memory to store specific information to calculate a specific time at which ink droplets discharged from the printer head enter the optical signal; and
a controller to recognize an ink-discharging amount upon receiving the comparison result from the comparator, and to restrict an ink-discharging operation of the light-receiving element using an enable signal, so that the first operation is conducted in the range from a start time at which the ink droplets enter the optical signal using the information stored in the memory to an end time at which the ink droplets escape from the optical signal, and to perform the second operation after the ink droplets escape from the optical signal.

9. An inkjet image forming apparatus, comprising:
a printer head equipped with a nozzle used for a deflected-discharging operation;
an ink-detection unit to detect ink droplets deflection-discharged from the printer head; and
a controller to recognize a nozzle state of the printer head to discharge the deflection-discharging operation.

10. The apparatus according to claim 9, wherein:
if the detection time of the ink droplets deflection-discharged from the printer head leads a reference time or lags behind the reference time, the controller determines that the nozzle is in a poor status.

11. The apparatus according to claim 9, further comprising:
a memory to store information calculating the detection time of the ink droplets deflection-discharged.

12. The apparatus according to claim 11, wherein the information stored in the memory includes an ink-discharging speed, a moving distance between recording-medium locations which are different according to a vertical discharging action and a deflection-discharging action, a deflection angle, and a flying distance provided when the ink droplets discharged from the printer head performing the deflection-discharging operation reach an optical signal.

13. The inkjet image forming apparatus of claim 3, wherein the controller determines the ink-droplet recognition time while the respective ink droplets are flying in correspondence with a width of the light.

14. The inkjet image forming apparatus of claim 13, wherein the controller determines the ink-droplet recognition time by recognizing a speed of the respective ink droplets ejected from the printer head and a distance between the ink detection unit and the printer head.

15. The inkjet image forming apparatus of claim 13, wherein the ink detection unit blocks a light signal after the respective ink droplets have reached the light.

16. A method of operating an inkjet image forming apparatus, the method comprising:
ejecting ink droplets;
transmitting a light to detect a presence of the ink droplets; and
determining an ink-droplet recognition time while the respective ink droplets are flying in correspondence with a width of the light.

17. A computer-readable recording medium having embodied thereon a computer program to execute a method, wherein the method comprises:
ejecting ink droplets;
transmitting a light to detect a presence of the ink droplets; and
determining an ink-droplet recognition time while the respective ink droplets are flying in correspondence with a width of the light.
